(19) United States
(12) Patent Application Publication
(10) Pub. No.: US 2012/0283020 A1
(43) Pub. Date: Nov. 8, 2012

(54) METHOD AND SYSTEM FOR PROVIDING GAME SERVICE USING USER INFORMATION

(76) Inventor: Jee In KIM, Seoul (KR)

(21) Appl. No.: 13/463,836

(22) Filed: May 4, 2012

(30) Foreign Application Priority Data
May 4, 2011 (KR) 10-2011-0042529

(51) Int. Cl. A63F 13/12

(52) U.S. Cl. 463/42

(57) ABSTRACT

Disclosed is a method and system for providing a game service, acquiring information about a user from a server offering a social network service and using the acquired user information, in a game environment managing an entity group including one or more entities, in which the entity group is formed by receiving user information of a user, who is accessing the terminal, from a third party server and creating an acquaintance group of the user based on the user information, receiving a selection of the acquaintance group, and matching a record, which corresponds to the selected acquaintance, with entity included in the entity group. The game service is provided to a terminal of the user with reference to the entity group.

### BACKGROUND

1. Technical Field

The present invention relates generally to game services, and particularly to a method and system for providing game services, using information about users acquired from a server offering social network services.

2. Related Art

Online game services generally enable gamers, i.e. users connected thereto, to interact with other users. But gamers' partnerships built through such online game services are usually restrictive in systems offering the games. On the other hand, systems offering social network services are advantageous for users to easily acquire private human networks, but incapable of applying previous human networks to other systems still because they are effective just in their corresponding systems. Thus, there have been demands for preparing advanced game services engaging with social network services.

That is, although a user acquires a human network that is built through a social network service while playing a game, he can only inform his acquaintance that he is playing the game or be informed that the game player (who has been already playing the game) is his acquaintance and play the game with the informed acquaintance. Therefore, it is difficult for a user to sense that he is enjoying a game with his acquaintance even when playing the game and there is no way to aggressively introduce an acquaintance, who is not concerned in the game, into the game.

### SUMMARY

Accordingly, the present invention is directed to providing a game service using information of the user.

The present invention is also directed to a game service using a human network built through a social network service.

The present invention is also directed to a game service capable of engaging with a social network while a user is playing the game.

The present invention is further directed to increasing familiarity and interest in a game, making a user sense he is playing the game with his acquaintance by permitting the user to apply the acquaintance of his human network to his entity of the game.

The present invention is further directed to maximizing sociality as well as interest in a game, enabling to stack up resources necessary for the game, e.g. game level, game money, etc. (hereinafter referred to as “game point”), on a record assigned to a user's acquaintance and then permitting the acquaintance to confirm the stacked game points, thereby making the acquaintance sense he is accumulating his own game points along with the user.

The present invention is still further directed to introducing more users into a game by allowing an acquaintance, who first begins the game, to use game points staked from a user's playing and hence lessening disinclination for his first game.

In an embodiment, a method for providing a game service to a terminal in a game system managing an entity group including one or more entities, the method comprising configuring the entity group, and providing the game service to the terminal based on the entity group, wherein configuring the entity group comprises: receiving user information of a user, who is accessing the terminal, from a third party server and creating an acquaintance group of the user based on the user information, receiving a selection of the acquaintance group, and matching a record, which corresponds to the selected acquaintance, with entity included in the entity group

The user information may be information stored in the third party server, including information relevant to acquaintances of the user

The record may include information relevant to a corresponding acquaintance.

The record may be accessible by another terminal different from the user's terminal.

In an embodiment, creating the acquaintance group may comprise the step of including an acquaintance, who is the acquaintance of the user and mismatches with any entity of the entity group, into the acquaintance group.

In an embodiment, providing the game service may comprise the step of updating the record corresponding to the entity in the entity group.

In an embodiment, providing the game service may comprise the steps of providing the entity in a feature of the acquaintance corresponding to the entity.

In another embodiment, this method may further comprise the step of, if the selected acquaintance requests the game service through a terminal, transferring information, which is stored in the record corresponding to the acquaintance, to the terminal of the acquaintance.

In another embodiment, this method may further comprise the step of transferring information, which is stored in the record corresponding to the acquaintance, to the third party server.

In another embodiment, this method may further comprise the step of transferring an invitation message, which asks the acquaintance to make an account for the game service, to an account of the third party server of the acquaintance.

In another embodiment, this method may further comprise the step of, if the acquaintance triggers an event by selecting one or more entities from the user's entity group, depositing game points in the record corresponding to the acquaintance.

The present invention provides a game service using information of the user. The present invention also provides a game service using a human network built through a social network service. The present invention also provides a game service capable of engaging with a social network while a user is playing the game. The present invention is helpful to increasing familiarity and interest in a game, making a user sense he is playing the game with his acquaintance by permitting the user to apply the acquaintance of his human network to his entity of the game. Additionally, the present invention is useful to maximize sociality as well as interest in a game by enabling to stack up game points necessary for the game on a record assigned to a user's acquaintance and permitting the acquaintance to confirm the stacked game points, thereby making the acquaintance sense he is accumulating his own game points along with the user. Moreover, a user's acquaintance first beginning a game becomes less reluctant to his first game as he is allowed to use game points staked from the user's playing.

A further understanding of the nature and advantages of the present invention herein may be realized by reference to the remaining portions of the specification and the attached drawings.

### BRIEF DESCRIPTION OF THE DRAWINGS

The present invention is illustrated by way of example, and not by way of limitation, in the figures of the accompanying drawings and in which like reference numbers refer to similar elements and in which:

FIG. 1 is a diagram illustrating an overall scheme of a network according to an embodiment of the present invention;

FIG. 2 is a diagram illustrating a game service system according to a preferred embodiment of the present invention;

FIG. 3 is an example screenshot image according to a preferred embodiment of the present invention; and

FIGS. 4 and 5 are flow charts for game service according to a preferred embodiment of the present invention.

### DESCRIPTION OF EMBODIMENTS

Hereinafter, various exemplary embodiments will now be described more fully with reference to the accompanying drawings in which some exemplary embodiments are shown. However, specific structural and functional details disclosed herein are merely representative for purposes of describing exemplary embodiments of the present invention. The same reference numbers denote the same elements or components throughout the description and accompanying drawings.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. Also will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Especially in this description, the terminology used herein is for the purpose of describing particular embodiments only and is not intended to be limiting of exemplary embodiments, being defined as follows. As used herein, “entity” means an object controlled by a user in playing a game, for example, may be a baseball player controlled by a user, in which a baseball team can be referred to as “entity group”. Meanwhile, “user information” may include information relevant to a user playing a game, e.g. profile information such as a user's name, age, hobbies, favorites, etc., and acquaintance information such as a user's friends, seniors and juniors, etc. As used herein, “record” means a unit of information to be processed in a single packet, including a specified person's profile data, e.g. the specified person's name, age, hobbies, favorites, etc., which is stored in a system providing a game service nevertheless of whether the specified person is playing a game. Each record is labeled by profile information assigned to each user.

As an example, considering that profile information stored in a third party server is different among persons, the profile information can be used for labels of the records. In other words, one record can be arranged corresponding to one person, thereby differentiating and characterizing the records respectively.

In order to more specifically describe exemplary embodiments, various aspects will be hereinafter described in detail with reference to the attached drawings.

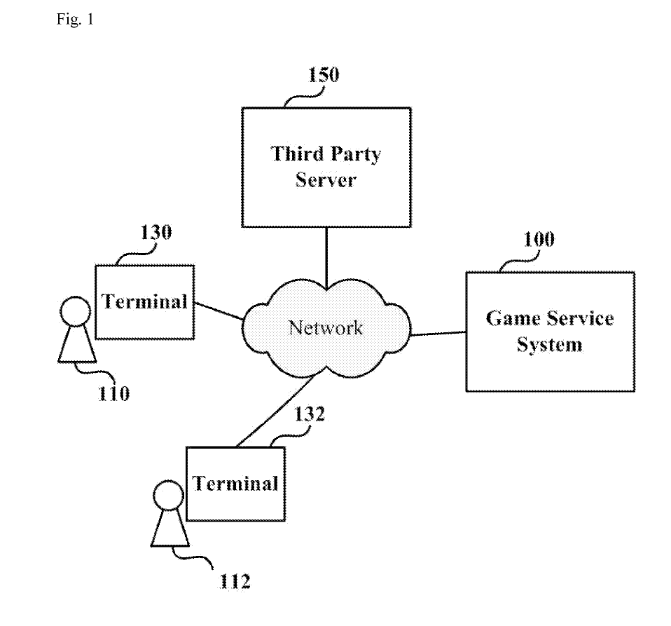

FIG. 1 illustrates an overall scheme of a network according to an embodiment of the present invention. As seen from FIG. 1, there are game service system 100 providing a game service, users 110 and 112 to access the game service system 100 in order to play a game, terminals 130 and 132 accessible by the users 110 and 112 respectively, and third party server 150, all of which are connected to the network and communicate each other through the network.

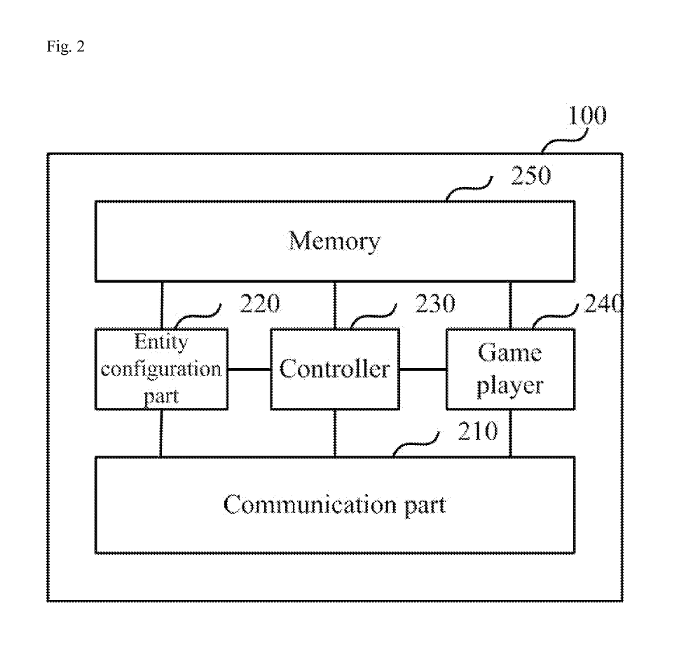

The terminals 130 and 132 may be one among game consoles, cellular phones, personal data assistants, general computers and portable multimedia players, including all units for accessing the game service system 100. By way of these terminals 130 and 132, the users 110 and 112 are able to access a game server to begin playing a game, or re-invoke game contents to play a game (hereinafter, “user” will be referred as a person to be provided with a game service through access to the game service system, or a person accessing a game server by way of a terminal). The third party server 150 acts as a server communicating with the game service system 100, containing information of the users 110 and 112, e.g. users' names, ages, hobbies or information about acquaintances linking to the users through human networks. The third party server 150 includes a server providing a social network service (e.g., Facebook; http://www.facebook.com). While FIG. 1 illustrates one of the third party server 150, it is available at need to make one or more third party servers communicate with the game service system 100 through the network. The game service system 100 will be now described in detail with reference to FIG. 2.

The game service system 100 is a system for providing a game service, especially a game service playing a game with one or more entities, which for example may be a game server generally commercialized and used. The game service system 100 is comprised of communication part 210, entity configuration part 220, controller 230, game player 240 and memory 250, all of which are coupled each other in communicable condition.

The communication part 210 connects the game service system 100 to the network out of the system, enabling the game service system 100 to communicate with the users' terminals 130 and 132 or the third party server 150.

The entity configuration part 220 forms an entity group for game playing before starting a game by the game player 240 or while a game is being played. In detail, the entity configuration part 220 operates to: acquire user information of a user playing a game from the third party server; identify and group user's acquaintances from the user information, selectively allocate several acquaintances each to entities from the acquaintance group; and create a record corresponding to an acquaintance allocated to the entity (if there is no record for the acquaintance) or search the corresponding record for the acquaintance allocated to the entity (if there is a record for the acquaintance). As like this manner an entity group is configured and the game player 240 receiving the entity group enables the user to play a game with the entity group, and when change happens to an entity, e.g. when game points are granted to the entity, updates the record of the acquaintance corresponding to the entity.

The controller 230 functions to control general operations of the communication part 210, the entity configuration part 230, the game player 240 and the memory 250. The controller 230 also performs all functions relevant to acquaintances corresponding to the entities, based on the entity group held in the entity configuration part 220. For instance, the controller 230 may send an invitation message for asking an acquaintance corresponding to an entity to play the game (or make an account in the game system for the game) and transfer data, which have been stacked in the acquaintance's own record, to the acquaintance's terminal or third party server or the account in the system 100 if the acquaintance joins in the game. In addition, the controller 230 may store an acquaintance's record, which is updated by a user's game playing, into the memory 250, transfer the updated information to an acquaintance's terminal, account or third party account. Moreover, the controller 230 may accumulate game points in an acquaintance's record when the acquaintance access to the game where the user is playing. Also, the controller 230 may accumulate game points in an acquaintance's record when the acquaintance access to the game where the user is playing and then for example generates an event by clicking an entity or an item around the entity group of the user. The controller 230 may also include other functions that those skilled in the art can expect for the operation of the game service system 100.

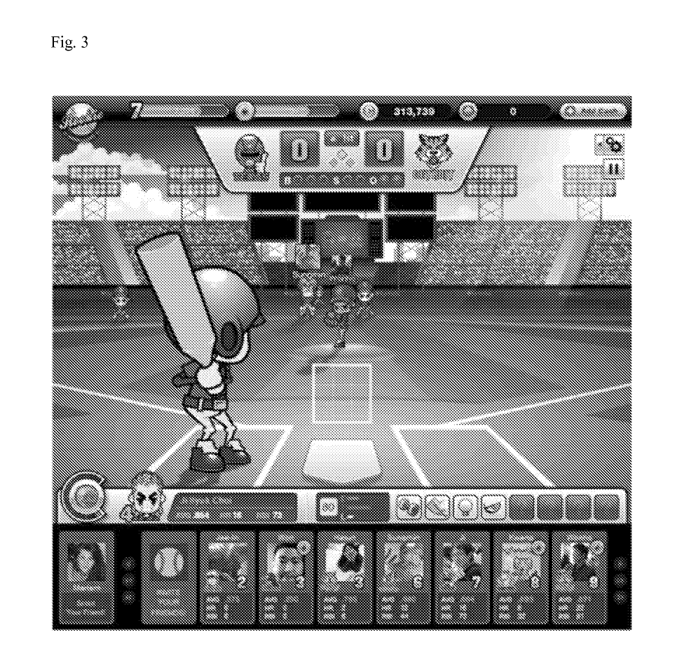

To make a user enjoy a game, the game player 240 provides all service tools, which are necessary for game play, to play with an entity group that is received from the entity configuration part 220. The game player 240 interacts with the user through the communication part 210, receives commands for game play from the user, and provides an entity in a feature of the acquaintance corresponding thereto while the game is being played. In other words, an entity can be configured in various manners capable of making a user intuitively acknowledge that he is playing a game together with his acquaintance, e.g. shaping an entity character into an acquaintance's appearance or displaying the acquaintance's name above the entity character. Exemplarily, as shown in FIG. 3, it is possible to display acquaintances' names above the entities, respectively, or to display the acquaintances' names and photographs, respectively, in the corresponding entities' deck at the bottom of the screen. Appearances for acquaintances may not be restrictive to those shown in FIG. 3, any type of which can be available to make a user intuit that an entity playing with him accords to the correspondent acquaintance.

Additionally, the game player 240 transfers entity's changes, which occur during game play, to the controller 230 and then the controller 230 stores the entity's changes in their corresponding acquaintances' records. For instance, a user is able to deposit a part of game points, which are stacked during game play, in an acquaintance's record corresponding to the entity of his entity group, or deposit a definite game point in an acquaintance's record corresponding to the entity of his entity group if he invests his own game point for the entity to enhance the game level of the entity or the entity group.

The memory 250 stores user information or records therein. These records are respectively allocated to persons having different profiles. When an acquaintance is newly identified with relevance to a user who is playing a game, a new record is allocated in the memory 250, corresponding to the profile, even unless the acquaintance is playing (i.e., although there is no game account for the acquaintance in the game service system). Contents of the records stored in the memory 250 are accessible and modifiable by all users playing a game.

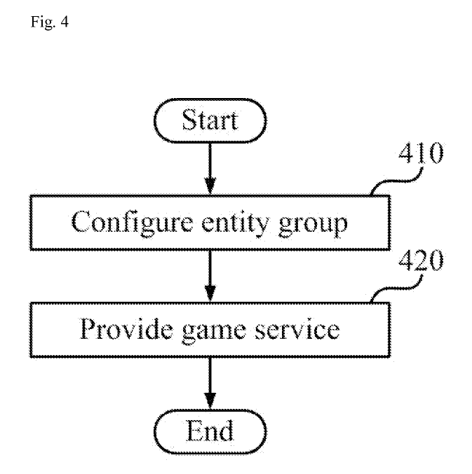

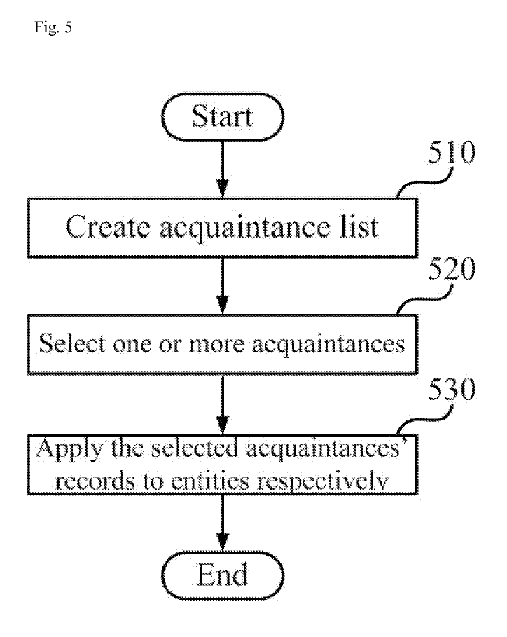

FIGS. 4 and 5 show procedures for game service according to a preferred embodiment of the present invention. If a user requests a game service capable of offering a playing mode with an entity group including one or more entities, the game service system forms the entity group using user information that is received from the third party server (step 410). During this, it is possible for users to play a game with entity features given as defaults, whereas they can configure entity groups by matching their acquaintances with entities. A process for matching user's acquaintances with his entity group will be more detailed referring to FIG. 5. With this entity group, a user is able to play a game (step 420). User may newly configure an entity group while playing a game, as well as playing the game after forming the entity group.

Referring to FIG. 5, now will be described an exemplary procedure for applying a user's acquaintance to his entity group.

In a gaming environment managing an entity group including one or more entities, user information is requested to the third party server which is communicating with the game service system. If the user information is received from the third party server in response to the request, acquaintances are arranged to create an acquaintance group after collecting information about the acquaintances familiar to the user using the user information (step 510). During this, an acquaintance preliminarily set in an entity can be even excluded from the acquaintance group. After constructing the acquaintance group, acquaintances included in the acquaintance group are selected (step 520). The number of acquaintances may be less than or equal to the number of entities necessary for consisting an entity group. Selecting acquaintances may be carried out by a user, or automatically executed in the game service system. It is possible that if the entities are set in default at the beginning and the acquaintances are selected smaller than the entities in number, some of the entities may remain as the default values. After selecting acquaintances, the selected acquaintances are set to be correspondent with entities included in an entity group (step 530). Meanwhile, as there are records respective to the acquaintances, the records for acquaintances are assigned each to the entities when the acquaintances are set to be correspondent with the entities. Thus, game points stacked while playing a game with such entities are deposited in the entities' corresponding records. Therefore, it enhances interest in game since a user can be provided with an image where he's entity group which he is playing with is consisted of his acquaintance. And, an acquaintance even who is not joining in the game at present can be interested therein and easily try to start the game by virtue of game points that have been deposited in his own record.

Hereinafter will be described an embodiment of operation in the game service system, regarding to a method for providing game service according to the present invention. It should be here understood that this embodiment is just provided for appropriate comprehension about the technical concept of the present invention and those skilled in this art can practice other more embodiments even without further descriptions.

For convenience of description, it is assumed that this game provided by the game service system 100 is exemplarily a baseball game capable of playing with a baseball team including a number of baseball players, there are personal users A, B, C and D who have never been provided with game service, and A and C are enrolled as acquaintances of B while C is an acquaintance of D.

When B begins this baseball game by accessing the game service system through the terminal, the game service game acquires user information of B from the third party server 150, and then creates an acquaintance group including A and C by using the user information of B that A and C are B's acquaintances. Then, if B selects and sets C as the fourth batter of the baseball team operated by him, the fourth batter is corresponding to C and represents C on the screen where B is playing the game, enhancing interest with feeling that B is enjoying the game together with C. During this, through various ways capable of rendering B to intuit C, it is available to make the fourth batter appear in a feature of C, e.g. shaping the appearance of the fourth batter's character to the appearance of C or continuously displaying C's name on the fourth batter character on the game screen. Information relevant to the fourth batter, changing while playing the game, is stored in the C's record. For instance, if the fourth batter corresponding to C hits a homerun while B is playing the game, its game point can be deposited in the C's record. And, while B is playing the game, if the fourth batter is put into a training program by using C's game point, the fourth batter's game points generated due to the training can be deposited partially or wholly in the C's record. Furthermore, there are other various ways of depositing game points in the acquaintances' records: for example, if the user B generates an event for his acquaintance while playing the baseball game, e.g. displaying an image of energetic beverage on the game screen, a game point can be deposited in the C's record when C triggers the event, i.e. when C clicks the image of energetic beverage.

On the other hand, if the user D begins the baseball game by accessing the game service system through the terminal, the game service system acquires user information of D from the third party server 150 and then creates an acquaintance group including C by identifying there is C as D's acquaintance. Then, if D selects and sets C as the first batter of the baseball team operated by him, the first batter is figured in C on the screen where B is playing the game and the first batter's information changing while D is playing the game is stored in the C's record preliminarily existed. During this, since each record is labeled as each own profile, game points stacked on the entity corresponding to C from playing by D are continuously deposited in the C's record that was created by the former B's operation. Consequently, while B and D select C and continue to play the game, game points are accumulatively deposited in the C's record.

As also, while B and D is being provided with game service, the game service system can deliver an invitation message for asking C to join in the game together, or send changed contents of the C's record thereto, to the C's third party server's account. Additionally, the game service system can send data to C stored in his own record when C accesses the game service system, and deposit game points when C attends to watch the game play of B.

As C who has not been participating in the game obtains accumulated game points in virtue of game play with B and D, he becomes interested in the game that he has not ever joined, more conveniently beginning the game using the accumulated game points without reluctance. Thus, it is easy to introduce a new user like C into the game. Moreover, since the game points used by game play of C are generated from the playing by B and D together, it is possible for B, C and D to have familiarity of sharing a social network each other even while competing among them in the game.

Now it can be seen that those skilled in the art are able even to implement such variously exemplified logic blocks and algorithmic steps, being described herein relative too the embodiments, by means of electronic hardware, computing software or combinations thereof. For the purpose of explaining these substitutions with hardware and software, the foregoing exemplary steps have been mainly described on the functional points of them. Whether such functions will be practiced by hardware and software is dependent upon specific applications and design conditions embedded in the whole system. Although artisans in this art can implement the aforementioned functions in a variety of ways respective to particular applications, those practical modifications or alterations may not be regarded and concluded as being out of the scope of the present invention.

The foregoing is illustrative of exemplary embodiments and is not to be construed as limiting thereof. Although a few exemplary embodiments have been described, those skilled in the art will readily appreciate that many modifications such as addition, omission, substitution, etc. are permissible in exemplary embodiments without materially departing from the novel teachings and advantages. Accordingly, all such modifications are intended to be included within the scope of this invention as defined in the claims without limit to the aforementioned description.

What is claimed is:

1. A method for providing a game service to a terminal in a game system managing an entity group including one or more entities, the method comprising:
configuring the entity group; and
providing the game service to the terminal based on the entity group,
wherein configuring the entity group comprises:
receiving user information of a user, who is accessing the terminal, from a third party server and creating an acquaintance group of the user based on the user information;
receiving a selection of the acquaintance group; and
matching a record, which corresponds to the selected acquaintance, with entity included in the entity group.

2. The method according to claim 1, wherein the user information is information stored in the third party server, including information relevant to acquaintances of the user.

3. The method according to claim 1, wherein the record includes information relevant to a corresponding acquaintance.

4. The method according to claim 1, wherein the record is accessible by another terminal different from the user's terminal.

5. The method according to claim 1, wherein creating the acquaintance group comprises including an acquaintance, who is the acquaintance of the user and mismatches with any entity of the entity group, into the acquaintance group.

6. The method according to claim 1, wherein providing the game service comprises updating the record corresponding to the entity in the entity group.

7. The method according to claim 1, wherein providing the game service comprises providing the entity in a feature of the acquaintance corresponding to the entity.

8. The method according to claim 1, further comprising, if the selected acquaintance requests the game service through a terminal, transferring information, which is stored in the record corresponding to the acquaintance, to the terminal of the acquaintance.

9. The method according to claim 1, further comprising transferring information, which is stored in the record corresponding to the acquaintance, to the third party server.

10. The method according to claim 1, further comprising transferring an invitation message, which asks the acquaintance to make an account for the game service, to an account of the third party server of the acquaintance.

11. The method according to claim 1, further comprising, if the acquaintance triggers an event by selecting one or more entities from the user's entity group, depositing game points in the record corresponding to the acquaintance.

12. A system for providing a game service playing a game with an entity group including one or more entities, the system comprising:
a communication part configured to communicate with a third party server;
an entity configuration part configured to form the entity group, receiving user information of a user from a third party server, creating an acquaintance group of the user based on the user information, receiving a selection of the acquaintance group, and matching a record, which corresponds to the selected acquaintance, with an entity included in the entity group;
a game player configured to receive the entity group from the entity configuration part and provide the game service based on the entity group; and
a memory configured to store the record and the user information.

13. The system according to claim 12, wherein the game player is configured to provide the entity in a feature of the acquaintance corresponding to the entity.

14. The system according to claim 12, further comprising a controller configured to update the record corresponding to the entity in the entity group.
